(19) United States
(12) Patent Application Publication
(10) Pub. No.: US 2025/0184231 A1
(43) Pub. Date: Jun. 5, 2025

(54) ELECTRONIC DEVICE, BASE STATION, AND COMMUNICATION SYSTEM FOR PERFORMING TRAFFIC PREDICTION

(71) Applicants: Samsung Electronics Co., Ltd., Suwon-si (KR); SEOUL NATIONAL UNIVERSITY R&DB FOUNDATION, Seoul (KR)

(72) Inventors: Sangwon PARK, Suwon-si (KR); Wan CHOI, Seoul (KR); Soohyun KIM, Suwon-si (KR); Peng XUE, Suwon-si (KR); Jinsoo AHN, Suwon-si (KR); Sun Ho KIM, Seoul (KR); Jae Duk LEE, Seoul (KR)

(21) Appl. No.: 18/984,374

(22) Filed: Dec. 17, 2024

Related U.S. Application Data
(63) Continuation of application No. PCT/KR2023/006843, filed on May 19, 2023.

(30) Foreign Application Priority Data
Jun. 17, 2022 (KR) 10-2022-0074360
Jun. 30, 2022 (KR) 10-2022-0080556

(51) Int. Cl. H04L 41/147; H04L 41/16; H04W 16/14

(52) U.S. Cl. CPC H04L 41/147; H04L 41/16; H04W 16/14

(57) ABSTRACT

An electronic device according to various embodiments comprises: a memory including instructions; and a processor that is electrically connected to the memory and executes the instructions. When the instructions are executed by the processor, the processor may: acquire a first traffic feature vector and a second traffic feature vector on the basis of traffic data generated in a wireless network device during a plurality of time intervals; generate a combined feature vector by combining the first traffic feature vector and the second traffic feature vector; and acquire predicted traffic data, to be generated in the wireless network device, on the basis of the combined feature vector. Various other embodiments are possible.

### TECHNICAL FIELD

The following description relates to an electronic device, a base station, and a communication system for performing traffic prediction.

### BACKGROUND ART

To improve network efficiency, stability, and performance, network resources (e.g., network bandwidth) need to be allocated effectively. The allocation of network resources is carried out using a network state at a future point in time, and for effective network resource allocation, it needs to be based on accurate prediction of network traffic at a future point in time.

Traffic prediction technology is divided into a method of directly predicting a traffic volume itself at a future point in time and a method of indirectly predicting a network situation through additional information about the traffic (e.g., a traffic type).

Technologies using a linear autoregressive model, a nonlinear autoregressive model, and a recurrent neural network (RNN) model, a type of deep neural network, have been proposed as the method of directly predicting the traffic volume. Recently, a technology of extracting features from traffic data and then performing traffic prediction using the extracted traffic features has been developed.

A technology of determining presence or absence of a traffic-dense session by comparing a variation in traffic over time with a threshold value has been studied as the method of indirectly predicting the network situation through additional information about the traffic. Also, a technology of predicting a maximum traffic rate based on grouped past traffic patterns has been studied.

### DISCLOSURE OF THE INVENTION

### Technical Goals

Some traffic prediction technologies only indirectly predict network situations and fail to predict a traffic volume itself. Effective network management requires a technology to predict the traffic volume itself, and technologies that indirectly predict the traffic volume may have limitations in prediction accuracy. Most technologies that directly predict the traffic volume may only perform long-term traffic prediction in units of hours (h), and may not perform short-term traffic prediction in units of milliseconds (ms).

Additionally, some traffic prediction technology requires additional information (e.g., an application type or statistical measurement) as an input to a traffic prediction device in addition to past traffic data. An operation of obtaining and processing the additional information may increase latency and device complexity, and the traffic prediction may not be performed without obtaining the additional information.

The technology of predicting the traffic volume itself introduces a linear model (e.g., an autoregressive integrated moving average (ARIMA) model) or a nonlinear model (e.g., Gaussian process regression (GPR) model), a Bayesian nonlinear model), but these models have the disadvantage of having lower model expression capabilities than deep neural network-based prediction models. Therefore, recently, there have been increasing attempts to perform traffic prediction through a deep neural network such as a recurrent neural network (RNN). However, an RNN-based traffic prediction model uses long traffic data as it is as an input to the prediction neural network, which may cause an increase in inference time. Accordingly, a technology for quickly predicting a short-term traffic volume with high accuracy may be required.

Various embodiments may provide a technology of accurately and quickly predicting subsequent traffic data.

The technical goals to be achieved are not limited to those described above, and other technical goals not mentioned above are clearly understood by one of ordinary skill in the art from the following description.

According to various embodiments, an electronic device may include a memory including instructions, and a processor electrically connected to the memory and configured to execute the instructions, and, when the instructions are executed by the processor, the processor may be configured to obtain a first traffic feature vector and a second traffic feature vector based on traffic data generated in a wireless network device during a plurality of time intervals, generate a concatenation feature vector by concatenating the first traffic feature vector and the second traffic feature vector, and obtain prediction traffic data to be generated in the wireless network device based on the concatenation feature vector.

According to various embodiments, a base station may include an antenna array including a plurality of antennas, a communication module configured to exchange data with a plurality of user terminals performing communication with a first network or a second network via the antenna array, and a processor operatively connected to the communication module, and the processor may be configured to, for each of the plurality of user terminals, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector, and perform dynamic spectrum sharing (DSS) of a heterogeneous network based on a plurality of prediction traffic data obtained for each of the plurality of user terminals.

According to various embodiments, a communication system may include a first base station configured to obtain a plurality of first network prediction traffic data to be generated in each of a plurality of user terminals performing communication with a first network, and transmit the plurality of first network prediction traffic data to a second base station, and the second base station configured to obtain a plurality of second network prediction traffic data to be generated in each of the plurality of user terminals performing communication with a second network, and perform DSS of a heterogeneous network based on the plurality of first network prediction traffic data and the plurality of second network prediction traffic data, and the first base station and the second base station may be configured to, for each of the plurality of user terminals, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector.

### EFFECTS OF THE INVENTION

Various embodiments may accurately and quickly predict subsequent traffic data using only past traffic data (e.g., a traffic volume) without additional information.

Various embodiments may accurately and quickly predict short-term traffic data by extracting traffic features through an autoencoder and performing concatenation of extracted traffic features.

Various embodiments may perform prediction of short-term traffic data quickly and accurately in an environment where short-term traffic prediction is required, such as a long term evolution (LTE)/new radio (NR) network DSS environment.

In addition, various effects directly or indirectly ascertained through the present disclosure may be provided.

### BRIEF DESCRIPTION OF DRAWINGS

FIG. 1 is a block diagram illustrating an electronic device 101 in a network environment 10 according to various embodiments.

FIG. 2 is a diagram illustrating an operation of obtaining prediction traffic data according to various embodiments.

FIG. 3 illustrates a flowchart of a method of training an autoencoder and a prediction neural network used for traffic prediction according to various embodiments.

FIG. 4 illustrates an example of training traffic sequence data according to various embodiments.

FIG. 5 is a diagram illustrating a method of training an autoencoder according to various embodiments.

FIG. 6 is a diagram illustrating a method of training a prediction neural network according to various embodiments.

FIG. 7 is a table showing results of comparing traffic prediction performance.

FIG. 8 is a diagram illustrating communication of a base station with a user terminal according to various embodiments.

FIG. 9 illustrates an example of a frame structure used in a long-term evolution (LTE)/new radio (NR) dynamic spectrum sharing (DSS) environment according to various embodiments.

FIG. 10 illustrates an example of a resource grid of an LTE/NR frequency division multiplexing (FDM) subframe according to various embodiments.

FIG. 11 illustrates an example of a resource grid of a subframe in which an LTE periodic signal is transmitted according to various embodiments.

FIG. 12 illustrates an example of a resource grid of a subframe in which an NR synchronization signal block (SSB) is transmitted according to various embodiments.

FIG. 13 illustrates an example of a resource grid of a subframe in which an NR tracking reference signal (TRS) is transmitted according to various embodiments.

FIG. 14 is a diagram illustrating LTE/NR network DSS performed by a single base station in a co-site base station environment according to various embodiments.

FIG. 15 illustrates a flowchart of an operation of LTE/NR network DSS performed in a co-site base station environment according to various embodiments.

FIG. 16 is a diagram illustrating LTE/NR network DSS performed in an inter-site base station environment according to various embodiments.

FIG. 17 illustrates a flowchart of an operation of LTE/NR network DSS performed in an inter-site base station environment according to various embodiments.

FIG. 18 is a table showing settings of a simulation for performance verification of a traffic prediction technology in an LTE/NR network DSS environment.

FIG. 19 illustrates a flowchart of a scheduling operation and a resource block (RB) allocation operation performed in an LTE/NR network DSS environment according to various embodiments.

FIG. 20 is a graph showing results of a simulation for performance verification.

### BEST MODE FOR CARRYING OUT THE INVENTION

Hereinafter, embodiments will be described in detail with reference to the accompanying drawings. When describing the embodiments with reference to the accompanying drawings, like reference numerals refer to like elements and a repeated description related thereto will be omitted.

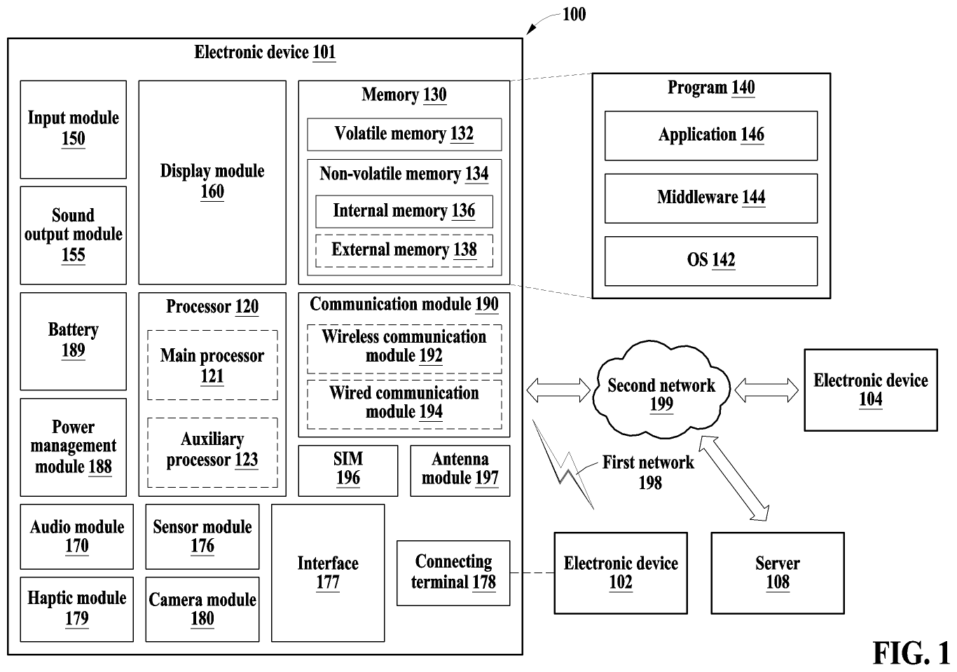

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 30 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an assistance processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for processing of an artificial intelligence (AI) model. An AI model may be generated by machine learning. Such learning may be performed by, for example, the electronic device 101 in which AI is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150, or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5^{th} generation (5G) network after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to one embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to one embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to embodiments, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

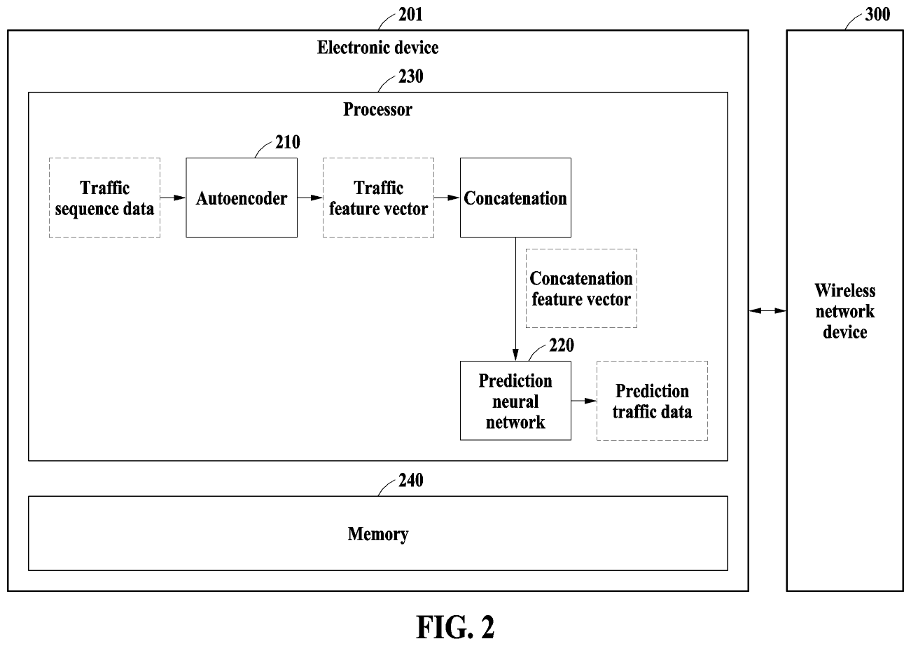

FIG. 2 is a diagram illustrating an operation of obtaining prediction traffic data according to various embodiments.

Referring to FIG. 2, according to various embodiments, an electronic device 201 may perform wireless network communication with a wireless network device 300. The electronic device 201 may obtain prediction traffic data of the wireless network device 300 based on traffic sequence data of the wireless network device 300. The electronic device 201 may include a processor 230 and a memory 240, and the electronic device 201 may correspond to an electronic device described above with reference to FIG. 1 (e.g., the electronic device 101 of FIG. 1). The wireless network device 300 may correspond to an electronic device described above with reference to FIG. 1 (e.g., the electronic device 102 or the electronic device 104 of FIG. 1). Therefore, a duplicated description of such described above with reference to FIG. 1 will be omitted.

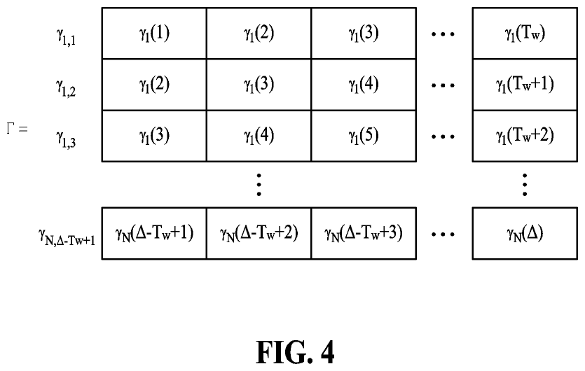

According to various embodiments, the processor 230 (e.g., the processor 120 of FIG. 1) may obtain a plurality of pieces of traffic sequence data by preprocessing traffic data generated from the wireless network device 300 during a plurality of time intervals. The operation of obtaining the plurality of pieces of traffic sequence data by the processor 230 will be described in detail with reference to FIG. 4.

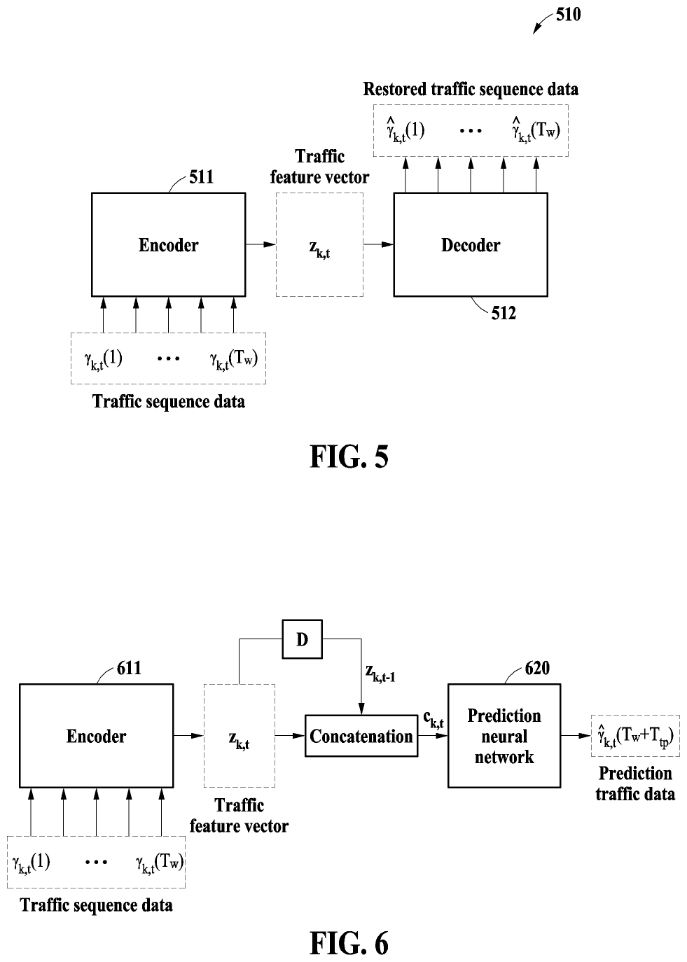

According to various embodiments, the processor 230 may obtain a plurality of traffic feature vectors based on the plurality of pieces of traffic sequence data. The processor 210 may obtain the plurality of traffic feature vectors (e.g., a first traffic feature vector and a second traffic feature vector) from the plurality of pieces of traffic sequence data (e.g., first traffic sequence data and second traffic sequence data) based on an autoencoder 210 trained based on training traffic sequence data. The operation of training the autoencoder 210 by the processor 230 will be described in detail with reference to FIG. 5.

According to various embodiments, the processor 230 may generate a concatenation feature vector by concatenating the plurality of traffic feature vectors (e.g., the first traffic feature vector and the second traffic feature vector). The concatenation feature vector is generated by concatenation of the plurality of traffic feature vectors (e.g., the first traffic feature vector and the second traffic feature vector) obtained based on a plurality of pieces of traffic data generated in the wireless network device 300 during a plurality of time intervals (e.g., a first time interval and a second time interval).

According to various embodiments, the processor 230 may obtain prediction traffic data to be generated in the wireless network device 300 based on the concatenation feature vector. The processor 230 may obtain prediction traffic data from the concatenation feature vector based on a prediction neural network 220 trained jointly with the autoencoder 210 based on the training traffic sequence data. The operation of training the prediction neural network 220 by the processor 230 will be described in detail with reference to FIG. 6.

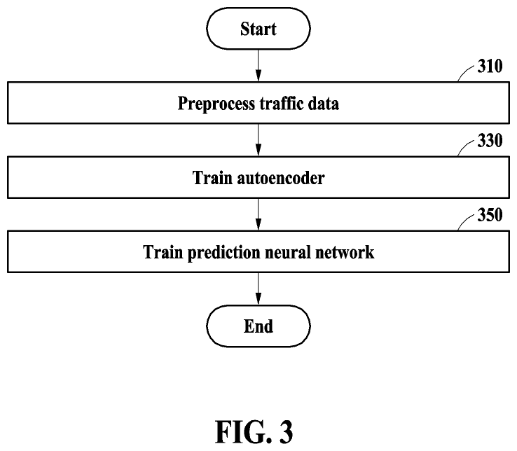

FIG. 3 illustrates a flowchart of a method of training an autoencoder and a prediction neural network used for traffic prediction according to various embodiments, FIG. 4 illustrates an example of training traffic sequence data according to various embodiments, FIG. 5 is a diagram illustrating a method of training an autoencoder according to various embodiments, and FIG. 6 is a diagram illustrating a method of training a prediction neural network according to various embodiments.

Operations 310 to 350 may be performed sequentially, but not be necessarily performed sequentially. For example, the order of operations 310 to 350 may be changed, and at least two of operations 310 to 350 may be performed in parallel.

In operation 310, a processor (e.g., the processor 230 of FIG. 2) may perform preprocessing of traffic data. Referring to FIG. 4, the processor 230 may perform the preprocessing to generate training traffic sequence data Γ based on the traffic data. The traffic data may be a traffic volume generated during a unit of time (e.g., u ms, 1 time step). For example, traffic data γ₁(1) may be a traffic volume generated during a first time step in a first wireless network device. In another example, traffic data γ_{N}(4) may be a traffic volume generated during a Δ-th time step in a N-th wireless network device.

According to various embodiments, the processor 230 may generate traffic sequence data by aggregating traffic data generated in a wireless network device during an arbitrary time interval (e.g., Tw time steps). The processor 230 may generate a plurality of pieces of traffic sequence data based on Δ pieces of traffic data generated for each wireless network device. The processor 230 may generate one piece of traffic sequence data based on Tw pieces of traffic data. For example, the processor 230 may obtain first traffic sequence data γ_{1,1} of the first wireless network device based on traffic data (γ₁(1), γ₁(2), γ₁(3), . . . , and γ₁(T_{w})) generated during a first time step to a Tw-th time step, respectively, in the first wireless network device. In another example, the processor 230 may obtain second traffic sequence data γ_{1,2} of the first wireless network device based on traffic data (γ₁(2), γ₁(3) . . . , γ₁(T_{w}), and γ₁(T_{w}+1)) generated during the second time step to a (Tw+1)-th time step, respectively, in the first wireless network device. The processor 230 may obtain Δ−T_{w}+1 pieces of traffic sequence data for each wireless network device. In other words, traffic sequence data γ_{k,i} may be i-th (herein, i∈[1, Δ−T_{w}+1]) traffic sequence data of a k-th wireless network device.

According to various embodiments, the processor 230 may obtain a set γₖ of pieces of traffic sequence data of the k-th wireless network device based on the pieces of traffic sequence data of the k-th wireless network device. The set γₖ of the pieces of traffic sequence data of the k-th wireless network device may satisfy Mathematical Expression 1.

$${γ}_{k} = [ {γ}_{k , 1} ; {γ}_{k , 2} ; … ; {γ}_{k , Δ - {T}_{w} + 1} ] \qquad [ Mathematical Expression 1 ]$$

$${γ}_{k} ∈ {ℝ}^{Δ}$$

According to various embodiments, the total number of wireless network devices may be N (e.g., k∈[1, N]), and the processor 230 may obtain the training traffic sequence data Γ (herein, Γ∈ [symbol] based on a set of traffic sequence data of N wireless network devices. The processor 230 may divide the training traffic sequence data Γ into a training set and a test set (e.g., training set: 8, test set: 2), and train the autoencoder and the prediction neural network based on the training set and the test set.

In operation 330, the processor 230 may train the autoencoder based on the training traffic sequence data Γ. Referring to FIG. 5, the processor 230 may train an autoencoder 510 to extract a traffic feature vector. The autoencoder 510 may be a long short-term memory (LSTM)-based autoencoder. The autoencoder 510 may include an encoder 511 and a decoder 512. The encoder 511 may receive traffic sequence dt (γ_{k,t}: γ_{k,t}(1) to γ_{k,t}(T_{w}) and output a traffic feature vector (z_{k,t}=fₑ(γ_{k,t}, θₑ). The decoder 512 may output traffic sequence data (\hat{γ}_{k,t}=f_{d}(z_{k,t}, θ_{d}): \hat{γ}_{k,t}(1) to \hat{γ}_{k,t}(T_{w})) restored based on a traffic feature vector z_{k,t} output by the encoder 511.

According to various embodiments, a loss function used for training of the autoencoder 510 may be represented by Mathematical Expression 2.

$${ℒ}_{AE} = \frac{1}{2 {T}_{w}} {\sum }_{i = 1}^{{T}_{w}} {( {\hat{γ}}_{k , t} ( i ) - {γ}_{k , t} ( i ) )}^{2} \qquad [ Mathematical Expression 2 ]$$

The processor 230 may update a neural network parameter θₑ of the encoder 511 and a neural network parameter θ_{d} of the decoder 512 to minimize the loss function [symbol] _{AE}. The processor 230 may update a neural network parameter through a stochastic gradient descent (SGD) method or an adaptive moment estimation (ADAM) method. For example, the processor 230 may update the neural network parameter using Mathematical Expression 3.

$${θ}_{e} ← {θ}_{e} - η {∇}_{{θ}_{e}} {ℒ}_{AE} \qquad [ Mathematical Expression 3 ]$$

$${θ}_{d} ← {θ}_{d} - η {∇}_{{θ}_{d}} {ℒ}_{AE}$$

In Mathematical Expression 3, η may be a learning rate.

In operation 350, the processor 230 may train a prediction neural network based on the training traffic sequence data Γ. Referring to FIG. 6, the processor 230 may train a prediction neural network 620 to extract the prediction traffic data. The prediction neural network 620 may include a fully connected layer. The prediction neural network 620 may be jointly trained with an autoencoder (e.g., the autoencoder 510 of FIG. 5) based on the training traffic sequence data Γ. An encoder 611 may output the traffic feature vector z_{k,t} from t-th traffic sequence data γ_{k,t} of the k-th wireless network device. The processor 230 may generate a concatenation feature vector c_{k,t}=[z_{k,t-1}; z_{k,t}] by concatenating a t-th traffic feature vector z_{k,t} and a (t−1)-th traffic feature vector z_{k,t-1}. The (t−1)-th traffic feature vector z_{k,t-1} may be a traffic feature vector output by the encoder 611 from (t−1)-th traffic sequence data γ_{k,t-1} of the k-th wireless network device. The prediction neural network 620 may output prediction traffic data \hat{γ}_{k,t} (T_{w}+Tₜₚ) based on the concatenation feature vector c_{k,t}. The prediction traffic data \hat{γ}_{k,t} (T_{w}+Tₜₚ) may be t+Tw+Ttp traffic data of the k-th wireless network device.

According to various embodiments, the processor 230 may train the prediction neural network 620. A loss function used to train the prediction neural network 620 may be represented by Mathematical Expression 4.

$${ℒ}_{TP} = \frac{1}{2} {( {\hat{γ}}_{k , t} ( {T}_{w} + {T}_{tp} ) - {γ}_{k , t} ( {T}_{w} + {T}_{tp} ) )}^{2} \qquad [ Mathematical Expression 4 ]$$

The processor 230 may update a neural network parameter θₚ of the prediction neural network 620 to minimize a loss function [symbol] _{TP}. The processor 230 may update the neural network parameter through the SGD method or the ADAM method. For example, the processor 230 may update the neural network parameter using Mathematical Expression 5.

$${θ}_{p} ← {θ}_{p} - η {∇}_{{θ}_{p}} {ℒ}_{TP} \qquad [ Mathematical Expression 5 ]$$

In Mathematical Expression 5, n may be a learning rate.

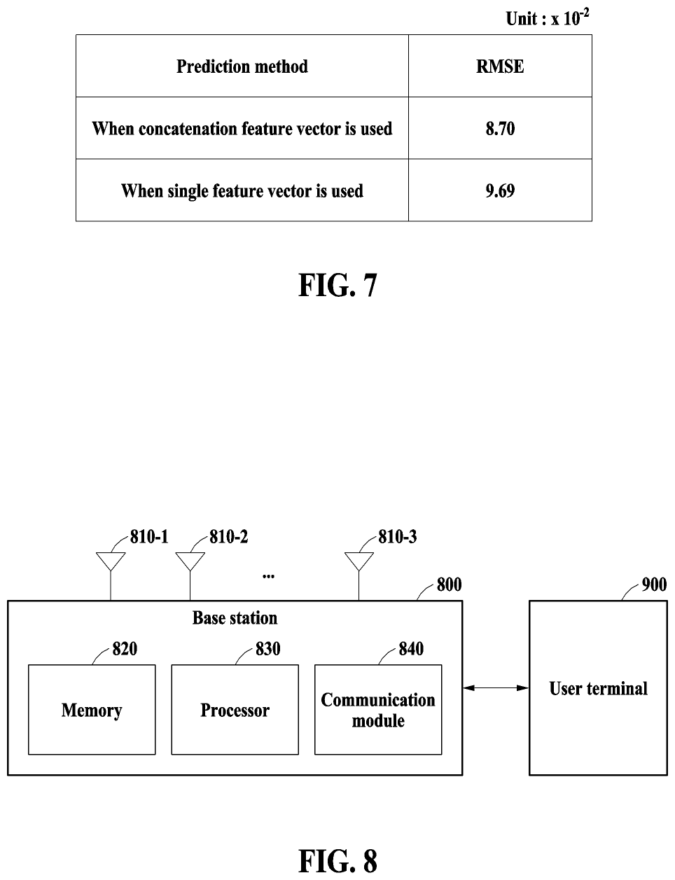

FIG. 7 is a table showing results of comparing traffic prediction performance.

Referring to FIG. 7, according to various embodiments, a traffic prediction result performed by an electronic device (e.g., the electronic device 201 of FIG. 2) using the concatenation feature vector may be compared with a traffic prediction result performed by a typical traffic prediction device using a single feature vector.

The simulation was performed using a voice over internet protocol (VoIP) traffic and file transfer protocol (FTP) traffic, however, the traffic types are not limited to the VOIP traffic and the FTP traffic. In the simulation, the VOIP traffic follows a Markov model consisting of an active and an inactive state, and a transition probability between the two states may be defined as p(t). In the active state, a packet having a size of M_{V}^{A} [MB] may be transmitted every 20 ms. In the inactive state, a silence insertion description (SID) packet having a size of M_{V}^{I} [MB] may be transmitted every 160 ms. It is assumed that the transition probability between the two states (e.g., the active state and the inactive state) is the same. A packet inter-arrival time of the FTP traffic may follow an exponential distribution (e.g., an exponential distribution in which a parameter is λ(t). A packet size of the FTP traffic may be fixed to M_{F} [MB].

At this time, a state transition probability p(t) of the VOIP traffic and a packet inter-arrival time parameter λ(t) of the FTP traffic may satisfy Mathematical Expression 6.

$$p ( t ) = \frac{{p}_{max} - {p}_{min}}{2} sin ( 2 π t / {T}_{p} ) + \frac{{p}_{max} + {p}_{min}}{2} , \qquad [ Mathematical Expression 6 ]$$

$$λ ( t ) = \frac{{λ}_{max} - {λ}_{min}}{2} sin ( 2 π t / {T}_{p} ) + \frac{{λ}_{max} + {λ}_{min}}{2} ,$$

In Mathematical Expression 6, Tp may be a period of a sine (sin) function, Pₘₐₓ, Pₘᵢₙ may be a maximum value and a minimum value of the state transition probability of the VoIP traffic, and λₘₐₓ, λₘᵢₙ may be a maximum value and a minimum value of the packet inter-arrival time parameter of the FTP traffic.

According to various embodiments, referring to FIG. 7, the performance of traffic prediction techniques may be compared using root mean square error (RMSE) values. The electronic device 201 may perform traffic prediction by using the concatenation feature vector to reduce the RMSE compared to a case of using a single feature vector. Hereinafter, a case of using the prediction traffic in an environment that requires the traffic prediction will be described.

FIG. 8 is a diagram illustrating communication of a base station with a user terminal according to various embodiments.

Referring to FIG. 8, according to various embodiments, a base station 800 and a user terminal 900 may perform wireless communication. The base station 800 may perform wireless communication with the user terminal 900 in an long-term evolution (LTE)/NR network dynamic spectrum sharing (DSS) environment. The DSS technology is a technology that allows a spectrum space to be dynamically shared by different types of networks (e.g., an LTE network and an NR network). For example, the DSS may enable a 4G LTE terminal to operate in the same frequency band and/or channel as a 5G NR terminal.

According to various embodiments, the base station 800 may be an entity that performs transmission and reception within a cell. A cell may be an individual service area controlled by the base station 800. The base station 800 may refer to a transmit point (TP), a transmit-receive point (TRP), an enhanced base station (eNB), a macro cell, a Wi-Fi access point (AP), or any component (or a set of components) configured to provide wireless access to other wireless communication devices. The base station 800 may include antenna arrays 810-1 to 810-n, a memory 820, a processor 830, and a communication module 840. The antenna arrays 810-1 to 810-n may include a plurality of antennas. The memory 820 may store one or more instructions to perform operations of the processor 830 and/or the communication module 840. The processor 830 may be operatively connected to the communication module 840. The communication module 840 may exchange data with the user terminal 900 through the antenna arrays 810-1 to 810-n.

According to various embodiments, the user terminal 900 may correspond to an electronic device (e.g., the electronic device 101, the electronic device 102, or the electronic device 104 of FIG. 1) described with reference to FIG. 1. With respect to the user terminal 900 (e.g., the electronic device 101 of FIG. 1), a repeated description provided with reference to FIG. 1 will be omitted. The user terminal 900 may include a mobile device, and the mobile device may refer to a device that receives services from a mobile communication system. The user terminal 900 may be implemented as a smart device such as a smartphone or a tablet personal computer (PC).

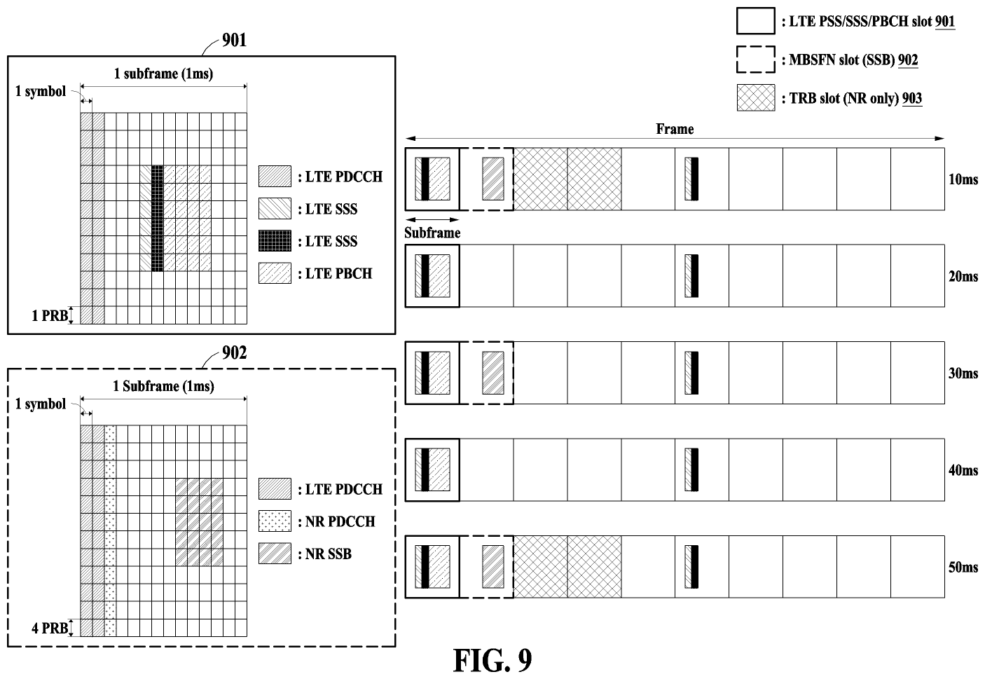

FIG. 9 illustrates an example of a frame structure used in a LTE/(NR) network DSS environment according to various embodiments.

An example of the LTE/NR network DSS environment will be described with reference to FIG. 9. A base station (e.g., the base station 800 of FIG. 8) may perform communication with a user terminal (e.g., the user terminal 900 of FIG. 9) in the LTE/NR network DSS environment. When the LTE/NR network DSS environment is performed, traffic information exchange and coordination may be performed between the LTE network and the NR network. In the LTE/NR network DSS environment, latency may be required. In the LTE/NR network DSS environment, a traffic prediction technology that may consider the latency and operate in transmission time interval (TTI) units of 1 ms may be required.

According to various embodiments, in the LTE/NR network DSS environment, necessary signals may exist in each network. A frame for transmitting signals consists of 10 ms, and each frame may consist of 10 subframes (e.g., a slot of 1 ms). A bandwidth may be 20 MHz, and the number of resource blocks (RBs) available in the LTE network and the NR network in the bandwidth of 20 MHz may be 100 and 106, respectively. A periodic signal used in the LTE network may be a primary synchronization signal/secondary synchronization signal (PSS/SSS) and a physical broadcast channel (PBCH). In the LTE network, the PSS/SSS may be transmitted at intervals of 5 ms, and PBCH may be transmitted at intervals of 10 ms. The PSS/SSS and the PBCH may be transmitted in a 0th subframe 901 of each frame, and the PSS/SSS may be transmitted in a fifth subframe. In the LTE network, the PSS/SSS/PBCH may occupy 6 physical RB (PRBs) and 4 symbols.

According to various embodiments, the periodic signal used in the NR network may be a synchronization signal block (SSB) and a tracking reference signal (TRS). In the NR network, the SSB may be transmitted at intervals of 20 ms, and the TRS may be transmitted at intervals of 40 ms. The SSB may be transmitted in a first subframe 902, and the TRS may be transmitted in a second subframe and a third subframe 903. The SSB may be transmitted across 20 PRBs, 4 symbols. The TRS may be allocated to 6 resource elements (REs) per PRB. It is assumed that a slot (subframe) in which the periodic signal is transmitted in the NR network is used in the NR network.

According to various embodiments, an essential reference signal for channel estimation and coherence decoding may be considered. The reference signal used in the LTE network may be a cell-specific reference signal (CRS). The reference signal used in the NR network may be a demodulation reference signal (DMRS) and the TRS. A control format indicator (CFI) of the LTE network may be 2, and the NR network may allocate a physical downlink control channel (PDCCH) only to a third orthogonal frequency division multiplexing (OFDM) symbol. A control channel element (CCE) unit for each network to configure the PDCCH is as shown in Table 1.

TABLE 1

| | LTE | NR |
|---|---|---|
| REG | 4RE | 12RE (1PRB × 1symbol) |
| CCE | 9REG (36RE) | 6REG (72RE) |

The PDCCH in the LTE network may consist of [symbol] _{LTE} (e.g., [symbol] _{LTE}∈{1,2,4,8}) CCEs, and the PDCCH in the NR network may consist of [symbol] _{NR} (e.g., [symbol] _{NR}∈{1,2,4,8,16}) CCEs. A maximum number of user terminals that may be allocated to each network in each slot t may be calculated using Mathematical Expression 7.

$${K}_{LTE}^{max} ( t ) = ⌊ \frac{{b}_{LTE}^{max} ( t ) {s}_{LTE}}{{ℓ}_{LTE} {c}_{LTE}} ⌋ \qquad [ Mathematical Expression 7 ]$$

$${K}_{NR}^{max} ( t ) = ⌊ \frac{{b}_{NR} ( t ) {s}_{NR}}{{ℓ}_{NR} {c}_{NR}} ⌋$$

$${c}_{i} = \{ \begin{matrix}3 RB , … for i = LTE , \\ 6 RB , … for i = NR\end{matrix} , {s}_{i} = \{ \begin{matrix}2 symbols , … for i = LTE , \\ 1 symbol , … for i = NR\end{matrix}$$

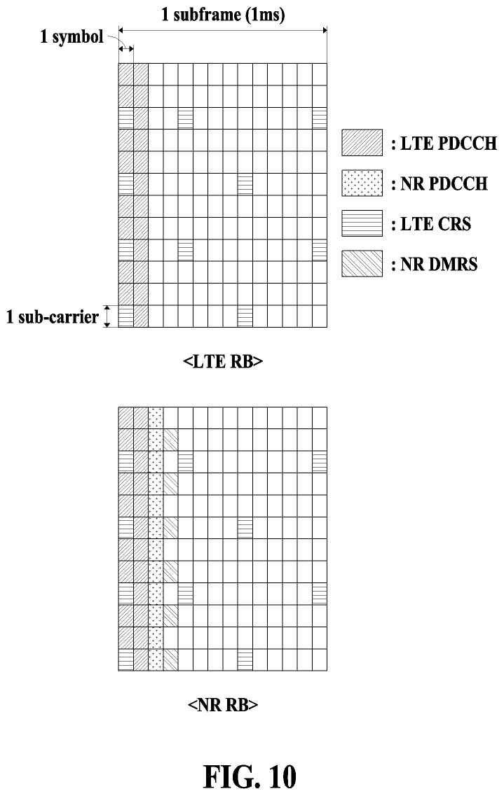

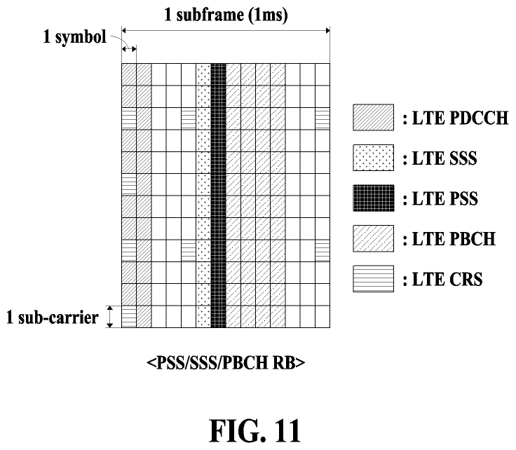

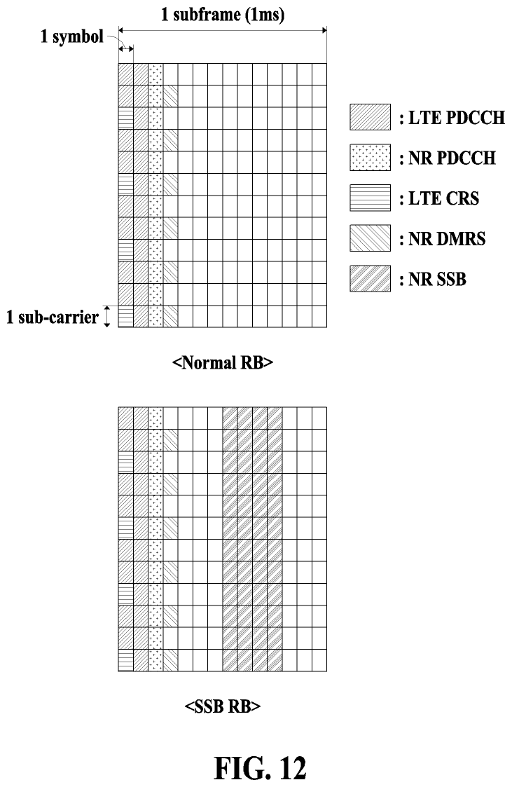

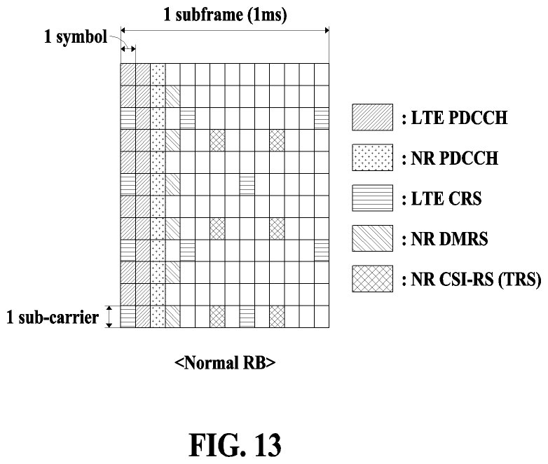

In Mathematical Expression 7, bᵢ^{max}(t) may be a maximum number of RBs that a network i (e.g., i∈{LTE, NR}) may be used in the slot t, bᵢ(t) may be an RB scheduled in the network i in the slot t, cᵢ may refer to the number of PRBs required for CCE configuration in the network i, and sᵢ may refer to a CFI of the network i. Examples of a frame structure considering essential signals of the LTE network and the NR network and RB resource grids of each network are shown in FIGS. 10 to 13. FIG. 10 illustrates an example of a resource grid of an LTE/NR frequency division multiplexing (FDM) subframe according to various embodiments, FIG. 11 illustrates an example of a resource grid of a subframe in which an LTE periodic signal is transmitted according to various embodiments, FIG. 12 illustrates an example of a resource grid of a subframe in which an NR SSB is transmitted according to various embodiments, and FIG. 13 illustrates an example of a resource grid of a subframe in which an NR TRS is transmitted according to various embodiments.

According to various embodiments, a proportion of REs that may be allocated to data transmission may vary depending on the RB due to a reference signal and a periodic signal required for each network system. Therefore, RB efficiency may be defined using the ratio of REs to which actual data may be transmitted excluding the total RE and overhead. When scheduling and RB allocation are performed in the LTE/NR network DSS environment, spectral efficiency and RB efficiency must be taken into consideration to consider the impact of overhead. The RB efficiency η may vary depending on the RB structure, and may be calculated by Mathematical Expression 8.

$$η = 1 - \frac{{RE}_{overhead}}{{RE}_{RB}} \qquad [ Mathematical Expression 8 ]$$

In Mathematical Expression 8, RE_{RB}, RE_{overhead} may be the number of REs composing each 1 RB, and the number of REs occupied by a control channel, a reference signal, and a periodic signal included in 1 RB.

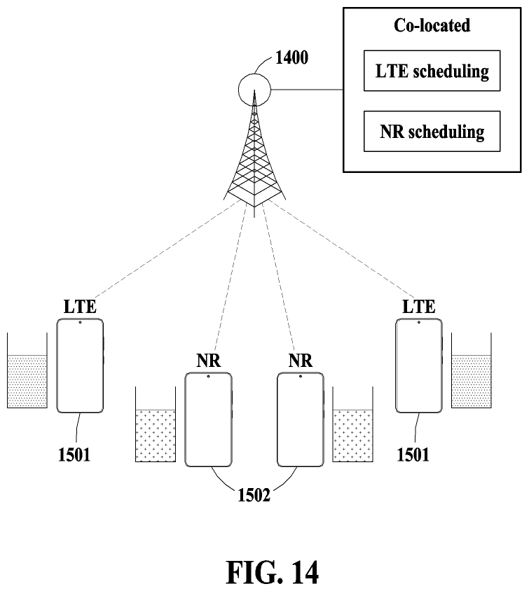

FIG. 14 is a diagram illustrating LTE/NR network DSS performed by a single base station in a co-site base station environment (e.g., environment in which the single base station supports the NR network communication and the LTE network communication) according to various embodiments.

Referring to FIG. 14, according to various embodiments, a base station 1400 may perform LTE/NR network DSS. At this time, latency for coordination of the LTE network and the NR network may be δ TTI, and individual user terminals 1501 and 1502 of each network i (e.g., i∈{LTE, NR}) may only statically request FTP traffic or VoIP traffic. Also, user terminals for each traffic type j (e.g., j∈{FTP, VolP}) of the network i may follow a Poisson arrival process, in which an arrival rate is Λ_{i,j}, and exponential distribution in which a session duration is parameter Φ_{i,j} small-scale fading model in a downlink wireless channel may be a first-order Gauss-Markov fading model. Channel gains of individual user terminals at each TTI may be the same across the entire band. In the first-order Gaussian-Markov fading model, a small-scale fading channel gain h_{k,t} at t-th TTI of a user terminal k may be represented by Mathematical Expression 9.

$${h}_{k , t} = ρ {h}_{k , t - 1} \sqrt{1 - {ρ}^{2}} {g}_{k , t} \qquad [ Mathematical Expression 9 ]$$

$${g}_{k , t} \sim 𝒞𝒩 ( 0 , 1 )$$

$${h}_{k , 0} = {g}_{k , 0}$$

In Mathematical Expression 9, ρ may be a correlation coefficient.

According to various embodiments, the base station 1400 may perform LTE/NR network DSS by performing scheduling and RB allocation. The scheduling may be scheduling a RB ratio of a shared band to be allocated to each network at each TTI through coordination between the LTE network and the NR network. The RB allocation may be allocation of the scheduled RBs to the user terminal in each network. The scheduling and the RB allocation may be performed in TTI units of 1 ms. The scheduling and the RB allocation may be performed in response to an RB group (RBG), and RBs that are not used due to unit differences between the RBG of LTE and the RBG of NR may be scheduled in the LTE network or the NR network and used in RB units. The RBG of LTE may be composed of 4 RBs, and the RBG of NR may be composed of 8 RBs.

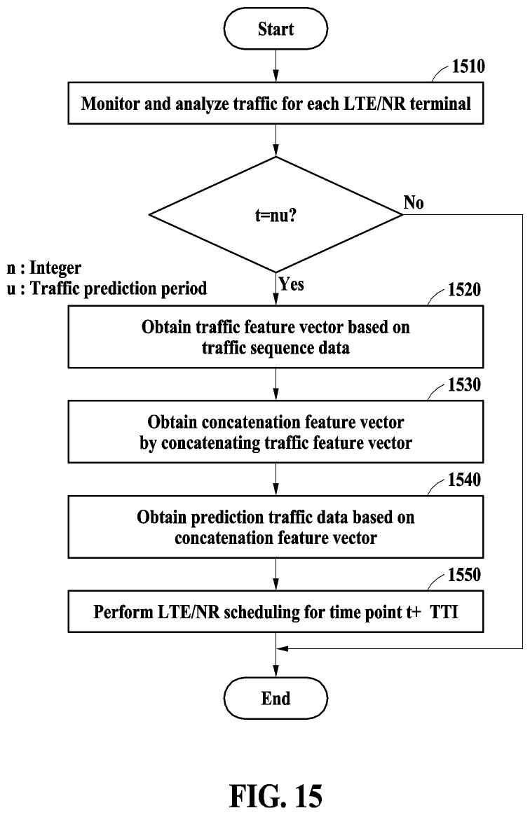

FIG. 15 illustrates a flowchart of an operation of LTE/NR network DSS performed in a co-site base station environment according to various embodiments.

Operations 1510 to 1550 may be performed sequentially, but not be necessarily performed sequentially. For example, the order of operations 1510 to 1550 may be changed, and at least two of operations 1510 to 1550 may be performed in parallel.

In operation 1510, a base station (e.g., the base station 1400 of FIG. 14) may perform traffic monitoring for each LTE/NR terminal (e.g., the terminals 1501 and 1502 of FIG. 14).

In operations 1520 to 1540, the base station 1400 may perform traffic prediction for each of the user terminals 1501 and 1502 for the LTE/NR network DSS. The traffic prediction may be performed for each u TTI (u ms) instead of each TTI (1 ms). The base station 1400 may perform the traffic prediction for each of the user terminals 1501 and 1502 at a time point t (where t=nu TTI). For example, the base station 1400 may generate traffic sequence data γ_{k,t} by aggregating traffic data received from the user terminal k at the time point t. The traffic sequence data γ_{k,t} may be traffic sequence data of the user terminal k at the time point t. In other words, the traffic sequence data γ_{k,t} may be obtained by aggregating traffic data generated in the user terminal k between time interval (e.g., a time point t−Tw*u+1 TTI to a time point t TTI).

In operation 1520, the base station 1400 may obtain a traffic feature vector (e.g., z_{k,t}) from the traffic sequence data (e.g., γ_{k,t}) based on an encoder (not shown) included in the trained autoencoder (e.g., the autoencoder 210 of FIG. 2). For example, the traffic feature vector z_{k,t} may be a traffic feature vector of the user terminal k at the time point t.

In operation 1530, the base station 1400 may obtain a concatenation feature vector (e.g., c_{k,t}=[z_{k,t-1}; z_{k,t}]) by concatenating a traffic feature vector (e.g., z_{k,t-1}) extracted earlier (e.g., before 1 time step) than the extracted traffic feature vector (e.g., z_{k,t}) and the traffic feature vector (e.g., z_{k,t}) extracted in operation 1520. For example, the concatenation feature vector c_{k,t} may be a concatenation feature vector of the user terminal k at time point t.

In operation 1540, the base station 1400 may obtain prediction traffic data (e.g., \hat{γ}_{k,t}(T_{w}+Tₜₚ)) from the concatenation feature vector (e.g., c_{k,t}) based on a prediction neural network (e.g., the prediction neural network 220 of FIG. 2). For example, the prediction traffic data \hat{γ}_{k,t}(T_{w}+Tₜₚ) may be traffic data of the k-th wireless network device of a time point +Tw+Ttp TTI. In other words, the prediction traffic data \hat{γ}_{k,t}(T_{w}+Tₜₚ) may be traffic data to be generated from the user terminal k between the time intervals (e.g., a time point t+δ+1 TTI to a time point t+δ+u TTI). A relationship between a prediction type step Ttp and latency δ may be represented by Mathematical Expression 10.

$${T}_{tp} = δ / u + 1 \qquad [ Mathematical Expression 10 ]$$

In operation 1550, the base station 1400 may generate LTE/NR scheduling information between the time interval (e.g., the time point t+δ+1 TTI to the time point t+δ+u TTI). The base station 1400 may generate the LTE/NR scheduling information between the time interval (e.g., the time point t+δ+1 TTI to the time point t+δ+u TTI) based on the prediction traffic data (e.g., \hat{γ}_{k,t}(T_{w}+Tₜₚ)) between the time interval (e.g., the time point t+δ+1 TTI to the time point t+δ+u TTI), previous prediction traffic data (e.g., \hat{γ}_{k,t-1}(T_{w}+Tₜₚ)), and previous scheduling information (e.g., scheduling information at a time point t−1). In other words, the base station 1400 may perform traffic prediction and scheduling information generation at the time point t TTI, and the base station 1400 may perform scheduling for the time interval (e.g., the time point t+δ+1 TTI to the time point t+δ+u TTI) during the time point t+1 TTI to the time point t+u TTI.

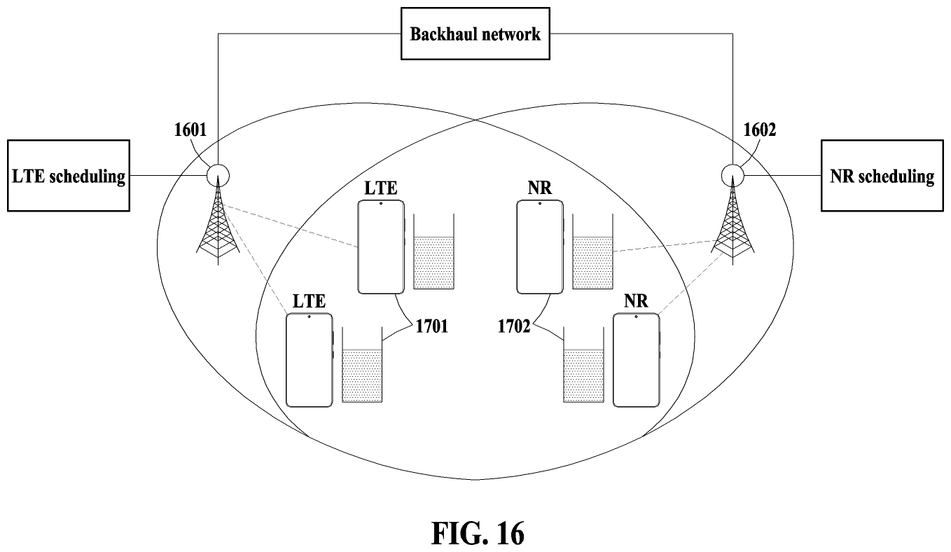

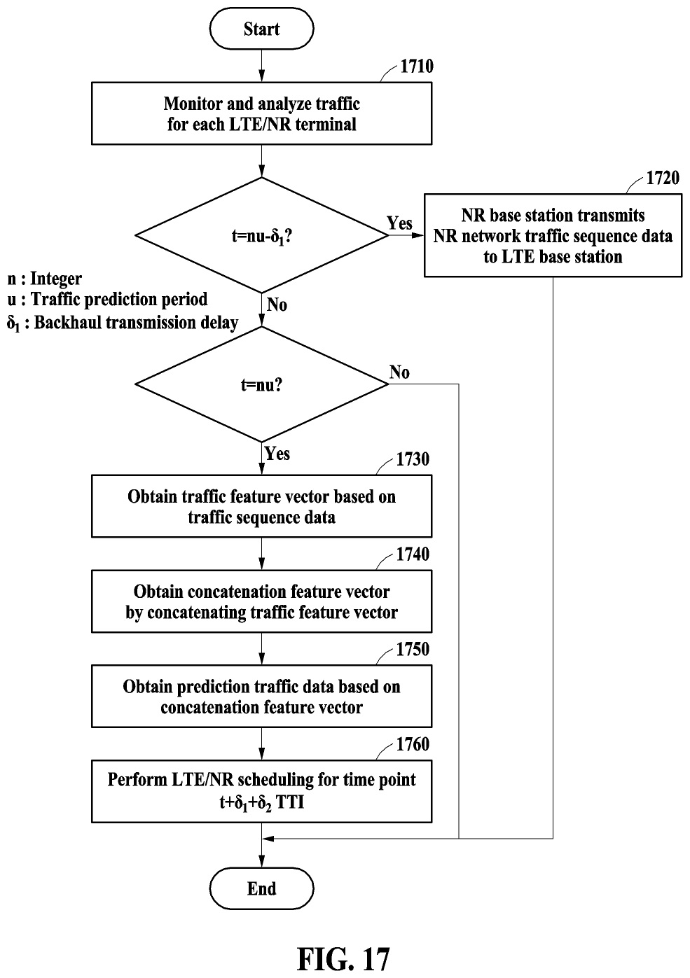

FIG. 16 is a diagram illustrating LTE/NR network DSS performed in an inter-site base station environment according to various embodiments, and FIG. 17 illustrates a flowchart of an operation of LTE/NR network DSS performed in an inter-site base station environment according to various embodiments. Referring to FIG. 16, according to various embodiments, an LTE base station 1601 may perform DSS of an LTE/NR network. The LTE base station 1601 may receive NR network traffic information from an NR base station 1602 through a backhaul network. The LTE base station 1601 may generate scheduling information using the received NR network traffic information. The LTE base station 1601 may transmit the generated scheduling information to the NR base station 1602 through the backhaul network. At this time, the latency for the network traffic information exchange and the scheduling information exchange may be δ₁ TTI, and the latency for the coordination of the LTE network and the NR network may be δ₂ TTI.

Referring to FIG. 17, operations 1710 to 1760 may be performed sequentially, but not be necessarily performed sequentially. For example, the order of operations 1710 to 1760 may be changed, and at least two of operations 1710 to 1760 may be performed in parallel.

In operation 1710, a base station (e.g., the base stations 1601 and 1602 of FIG. 16) may perform the traffic monitoring for each LTE/NR terminal (e.g., terminals 1701 and 1702 of FIG. 16). In operations 1720 to 1750, the LTE base station 1601 may perform the traffic prediction for each of the user terminals 1701 and 1702 for the LTE/NR network DSS. The traffic prediction may be performed for each u TTI (e.g., u ms) instead of each TTI (e.g., 1 ms). The LTE base station 1601 may generate LTE network traffic sequence data based on LTE network traffic data generated in the LTE terminal 1701, and the NR base station 1602 may generate NR network traffic sequence data based on NR network traffic data generated in the NR terminal 1702.

In operation 1720, the NR base station 1602 may generate the NR network traffic sequence data by aggregating the NR network traffic data received from the NR terminals 1702 at a time point t−δ₁ TTI (where t=nu TTI). The NR base station 1602 may transmit the NR network traffic sequence data to the LTE base station 1601.

In operation 1730, the LTE base station 1601 may extract the traffic feature vector from the traffic sequence data for each of the user terminals 1701 and 1702 based on an autoencoder (e.g., the autoencoder 210 of FIG. 2).

In operation 1740, the LTE base station 1601 may obtain a concatenation feature vector by concatenating a traffic feature vector extracted earlier (e.g., before 1 time step) than the extracted traffic feature vector and the traffic feature vector extracted in operation 1730.

In operation 1750, the LTE base station 1601 may obtain prediction traffic data from the concatenation feature vector for each of the user terminals 1701 and 1702 based on a prediction neural network (e.g., the prediction neural network 220 of FIG. 2). Each prediction traffic data may be traffic data to be generated in each of the user terminals 1701 and 1702 between the time interval (e.g., a time point t+δ₁+δ₂+1 TTI to a time point t+δ₁+δ₂+u TTI).

In operation 1750, the LTE base station 1601 may generate LTE/NR scheduling information between the time interval (e.g., the time point t+δ₁+δ₂+1 TTI to the time point t+δ₁+δ₂+u TTI). The LTE base station 1601 may generate the LTE/NR scheduling information between the time interval (e.g., the time point t+δ₁+δ₂+1 TTI to the time point t+δ₁+δ₂+u TTI) based on the prediction traffic data between the time interval (e.g., the time point t+δ₁+δ₂+1 TTI to the time point t+δ₁+δ₂+u TTI), previous prediction traffic data, and previous scheduling information (e.g., scheduling information at the time point t-1). The LTE base station 1601 may transmit the generated LTE/NR scheduling information to the NR base station 1602. When the LTE base station 1601 performs the traffic prediction at the time point t TTI, the LTE base station 1601 and the NR base station 1602 may perform the scheduling for the time interval (e.g., the time point t+δ₁+δ₂+1 TTI to the time point t+δ₁+δ₂+u TTI) between the time point t+1 TTI to the time point t+u TTI.

According to various embodiments, a device (e.g., the electronic device 201 of FIG. 2, the base station 800 of FIG. 8, the base station 1400 of FIG. 14, and the base stations 1601 and 1602 of FIG. 16) may generate a concatenation feature vector by utilizing traffic feature vectors from multiple time steps ago, not only a traffic feature vector of a previous time step, and perform the traffic prediction. Additionally, the device 201, 800, 1400, 1601, or 1602 may generate a concatenation feature vector by utilizing three or more past traffic feature vectors, and also perform the traffic prediction. Below, performance verification of a traffic prediction technology in an LTE/NR dynamic network environment will be performed.

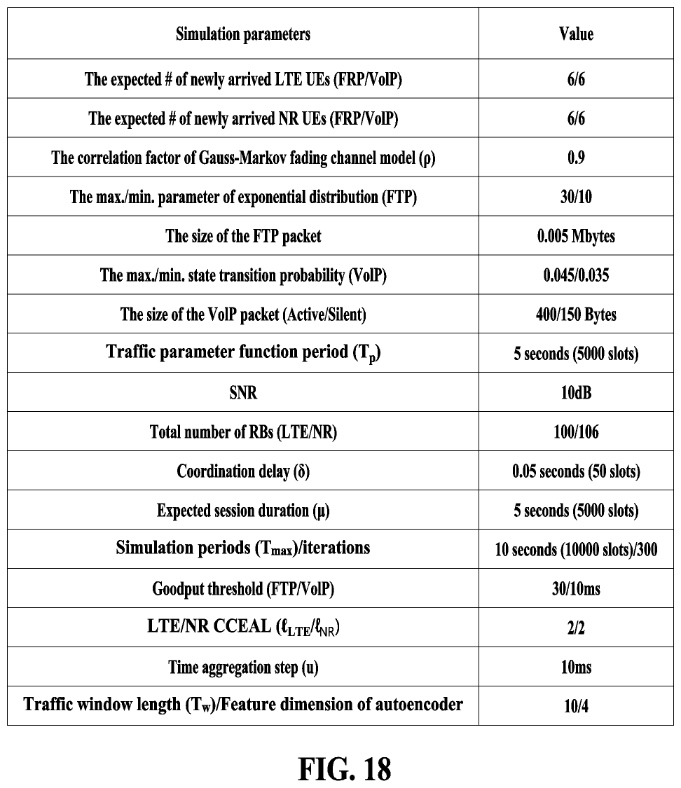

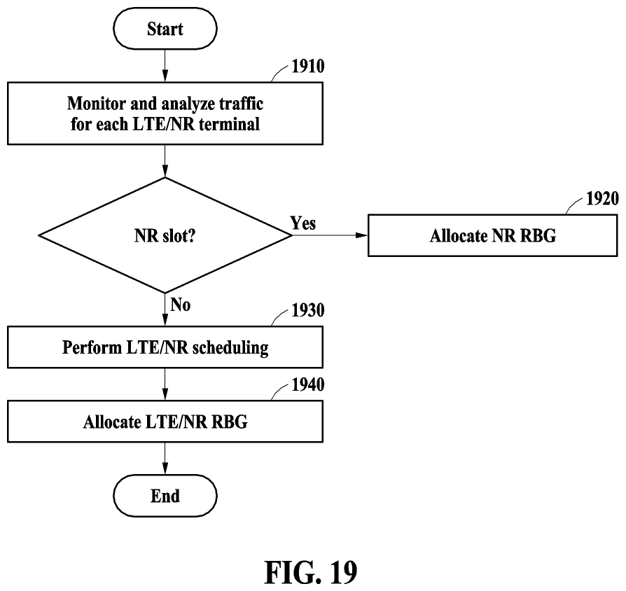

FIG. 18 is a table showing settings of a simulation for performance verification of a traffic prediction technology in an LTE/NR dynamic network environment, and FIG. 19 illustrates a flowchart of a scheduling operation and an RB allocation operation performed in an LTE/NR DSS environment according to various embodiments.

Referring to FIG. 18, the settings of a simulation for performance analysis when performing the DSS of the LTE/NR network may be confirmed by using a traffic prediction method in a co-site base station environment.

The scheduling method used in the simulation may be a proportional fair (PF) scheduling method and/or a utility proportional fair (UPF) scheduling method. The PF scheduling method may be a method of determining the priority of a user terminal using a PF metric calculated by Mathematical Expression 11.

$${PF}_{k} ( t ) = \frac{{r}_{k} ( t )}{{T}_{k} ( t - 1 )} \qquad [ Mathematical Expression 11 ]$$

In Mathematical Expression 11, PFₖ(t) may be the PF metric of the user terminal k. rₖ(t) may be an instantaneous rate of the user terminal k at the time point t TTI. Tₖ(t−1) may be a throughput of the user terminal k until t−1 TTI. The UPF scheduling method may be a method of designing a utility function in which different quality of service (QoS) constraints are reflected depending on the type of traffic, and performing the PF scheduling after mapping the traffic of individual user terminals to the utility function. A utility function U^{VoIP} (τₖ) of the VoIP traffic and a utility function U^{FTP}(τₖ) of the FTP traffic may be represented by Mathematical Expression 12.

$${U}^{VolP} ( {τ}_{k} ) = 1 - c ( \frac{1}{1 + {e}^{- a ( {τ}_{k} - b )}} - d ) \qquad [ Mathematical Expression 12 ]$$

$${U}^{FTP} ( {τ}_{k} ) = 1 - \frac{log ( 1 + {ψτ}_{k} )}{log ( 1 + {ψτ}^{max} )}$$

$$c = \frac{1 + {e}^{ab}}{{e}^{ab}} , d = \frac{1}{1 + {e}^{ab}}$$

In Mathematical Expression 12, τₖ may be a head-of-line (HOL) packet delay of the user terminal k, ψ may be a variation of the FTP utility function according to τₖ, and τ^{max} may be maximum allowable latency of the utility function. The UPF scheduling method may be a method of determining the priority of the user terminal using the UPF metric calculated by Mathematical Expression 13.

$${UPF}_{k} ( t ) = \frac{\vert {U}^{′} ( {τ}_{k} ( t ) ) \vert {x}_{k} ( t )}{U ( {τ}_{k} ( t ) )} \qquad [ Mathematical Expression 13 ]$$

In Mathematical Expression 13, UPFₖ(t) may be the UPF metric of each user terminal k, Uₖ(·) may be a utility function corresponding to the traffic type, and xₖ(t) may be spectral efficiency [bits/sec/Hz] of the user terminal k in a slot (subframe) t.

Referring to FIG. 19, an algorithm of scheduling and RB allocation performed in the LTE/NR DSS environment for performance analysis may be confirmed. In the LTE-NR scheduling, only a scheduling ratio that may be derived when allocating resources may be considered in consideration of the RB/RBG constraints of LTE/NR. Among available scheduling ratios, a scheduling ratio with a largest instantaneous rate of the RB allocation result may be searched through an exhaustive search method, and the scheduling may be performed using the searched result. A method of allocating the RB to individual user terminals for each network system may be a method of allocating the RBG starting from the user terminal with the highest priority through the PF metric or UPF metric. In the simulation for performance analysis, in order to reduce waste of the RB, the RB with the least overhead may be allocated among the RBGs that may be allocated for each network system.

Operations 1910 to 1940 may be performed sequentially, but not be necessarily performed sequentially. For example, the order of operations 1910 to 1940 may be changed, and at least two of operations 1910 to 1940 may be performed in parallel.

In operation 1910, traffic monitoring and analysis may be performed for each an LTE/NR terminal. In operation 1920, an RBG may be allocated to an NR corresponding to an NR slot. In operation 1930, the LTE/NR scheduling may be performed. In operation 1940, the RBG may be allocated to both LTE/NR. Hereinafter, the simulation results will be described.

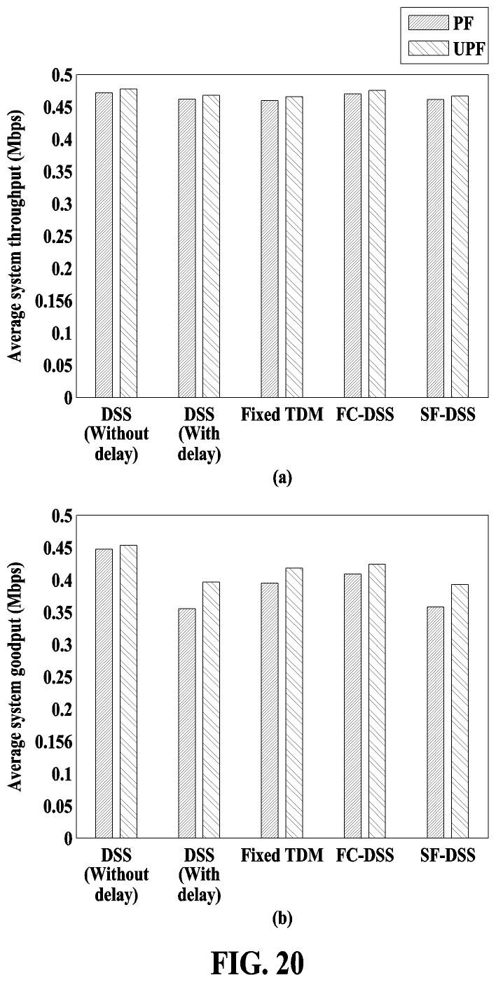

FIG. 20 is a graph showing results of a simulation for performance verification.

Referring to (a) of FIG. 20, throughput simulation results may be confirmed, and referring to (b) of FIG. 20, goodput simulation results may be confirmed.

The performance analysis was performed in an environment without coordination delay, an environment with coordination delay, and a fixed time division multiplexing (TDM) environment. Among the performance analysis environments, the environment without coordination delay may be an environment in which information scheduled to t TTI is used directly at t TTI. Among the performance analysis environments, the environment with coordination delay may be an environment in which information scheduled to t TTI is used at t+δ TTI. In the environment with coordination delay, the traffic information at t+δ TTI is not known, and therefore, it is assumed that an LTE-NR RB ratio at t+δ TTI is scheduled through a queue state and a channel gain at t TTI. Among the performance analysis environments, the fixed TDM environment may be a scheduling environment in which the LTE and the NR are alternately allocated for each TTI to slots other than a slot (subframe) (e.g., NR SSB,

TRS subframe) that must be allocated to the NR. Also, in the environment with coordination delay, performance when scheduling is performed using a concatenation feature vector-based traffic prediction technology (e.g., feature concatenation based dynamic spectrum sharing (FC-DSS)) and when scheduling is performed using a single feature vector-based traffic prediction technology (e.g., single feature based dynamic spectrum sharing (SF-DSS)) was also shown in FIG. 20.

Referring to the performance analysis results, it is observed that, when the scheduling is performed using the concatenation feature vector-based traffic prediction technology, both throughput and goodput are higher, compared to a case where the scheduling is performed without traffic prediction. In addition, it may be found that, when the scheduling is performed using the concatenation feature vector-based traffic prediction technology, accurately predicted traffic information may be used, compared to a case where the scheduling is performed using the single feature vector-based traffic prediction technology, and this results in good throughput performance and goodput performance.

An electronic device (e.g., the electronic device 201 of FIG. 2) according to various embodiments may include a memory (e.g., the memory 240 of FIG. 2) including instructions, and a processor (e.g., the processor 230 of FIG. 2) electrically connected to the memory 240 and configured to execute the instructions, and, when the instructions are executed by the processor 230, the processor 230 may be configured to obtain a first traffic feature vector and a second traffic feature vector based on traffic data generated in a wireless network device (e.g., the wireless network device 300 of FIG. 2) during a plurality of time intervals, generate a concatenation feature vector by concatenating the first traffic feature vector and the second traffic feature vector, and obtain prediction traffic data to be generated in the wireless network device based on the concatenation feature vector.

According to various embodiments, the processor 230 may be configured to generate first traffic sequence data and second traffic sequence data by aggregating traffic data generated in the wireless network device 300 for each time interval during a first time interval and a second time interval, and obtain each of the first traffic feature vector and the second traffic feature vector based on the first traffic sequence data and the second traffic sequence data.

According to various embodiments, the second time interval may have the same interval as the first time interval, and a starting point of the second time interval may be earlier than a starting point of the first time interval.

According to various embodiments, the processor 230 may be configured to obtain each of the first traffic feature vector and the second traffic feature vector from the first traffic sequence data and the second traffic sequence data based on a first neural network (e.g., the autoencoder 210 of FIG. 2) trained based on training traffic sequence data (e.g., the training traffic sequence data of FIG. 4).

According to various embodiments, the trained first neural network (e.g., the autoencoder 210 of FIG. 2) may be an autoencoder including an encoder configured to receive traffic sequence data and output a traffic feature vector; and a decoder configured to restore traffic sequence data received by the encoder based on the traffic feature vector output by the encoder.

According to various embodiments, the processor 230 may be configured to obtain the prediction traffic data from the concatenation feature vector based on a second neural network (e.g., a prediction neural network 220 of FIG. 2) trained jointly with the first neural network 210 based on the training traffic sequence data.

in A base station (e.g., the base station 800 of FIG. 8 or the base station 1400 of FIG. 14) according to various embodiments may include an antenna array including a plurality of antennas (e.g., the plurality of antennas 810-1 to 810-n of FIG. 8); a communication module (e.g., the communication module 840 of FIG. 8) configured to exchange data with a plurality of user terminals (e.g., the user terminal 900 of FIG. 8 or the user terminals 1501 and 1502 of FIG. 14) performing communication with a first network or a second network via the antenna array; and a processor (e.g., the processor 130 of FIG. 8) operatively connected to the communication module 840, and the processor 830 may be configured to, for each of the plurality of user terminals 900, 1501, 1502, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector, and perform DSS of a heterogeneous network based on a plurality of prediction traffic data obtained for each 20 of the plurality of user terminals 900, 1501, 1502.

According to various embodiments, the processor 830 may be configured to generate first traffic sequence data and second traffic sequence data by aggregating traffic data generated in the one user terminal for each time interval during a first time interval and a second time interval, and obtain each of the first traffic feature vector and the second traffic feature vector based on the first traffic sequence data and the second traffic sequence data.

According to various embodiments, the second time interval may have the same interval as the first time interval, and a starting point of the second time interval may be earlier than a starting point of the first time interval.

According to various embodiments, the processor 830 may be configured to obtain each of the first traffic feature vector and the second traffic feature vector from the first traffic sequence data and the second traffic sequence data based on a first neural network (e.g., the autoencoder 210 of FIG. 2) trained based on training traffic sequence data (e.g., the training traffic sequence data of FIG. 4).

According to various embodiments, the trained first neural network (e.g., the autoencoder 210 of FIG. 2) may be an autoencoder including an encoder configured to receive traffic sequence data and output a traffic feature vector, and a decoder configured to restore traffic sequence data received by the encoder based on the traffic feature vector output by the encoder.

According to various embodiments, the processor 830 may be configured to obtain the prediction traffic data from the concatenation feature vector based on a second neural network (e.g., the prediction neural network 220 of FIG. 2) trained jointly with the first neural network 210 based on the training traffic sequence data.

According to various embodiments, the first network may be any one of an LTE network or an NR network, and the second network may be the remaining one of the LTE network or the NR network, that is different from the first network.

A communication system according to various embodiments may include a first base station (e.g., the base station 1602 of FIG. 16) configured to obtain a plurality of first network prediction traffic data to be generated in each of a plurality of user terminals (e.g., the user terminal 1702 of FIG. 16) performing communication with a first network, and transmit the plurality of first network prediction traffic data to a second base station (e.g., the base station 1601 of FIG. 16), and the second base station (e.g., the base station 1601 of FIG. 16) configured to obtain a plurality of second network prediction traffic data to be generated in each of the plurality of user terminals (e.g., the user terminal 1701 of FIG. 16) performing communication with a second network, and perform DSS of a heterogeneous network based on the plurality of first network prediction traffic data and the plurality of second network prediction traffic data, and the second base station 1601 may be configured to, for each of the plurality of user terminals 1701, 1702, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector.

According to various embodiments, the second base station 1601 may be configured to generate first traffic sequence data and second traffic sequence data by aggregating traffic data generated in the one user terminal for each time interval during a first time interval and a second time interval, and obtain each of the first traffic feature vector and the second traffic feature vector based on the first traffic sequence data and the second traffic sequence data.

According to various embodiments, the second time interval may have the same interval as the first time interval, and a starting point of the second time interval may be earlier than a starting point of the first time interval.

According to various embodiments, the second base station 1601 may obtain each of the first traffic feature vector and the second traffic feature vector from the first traffic sequence data and the second traffic sequence data based on a first neural network (e.g., the autoencoder 210 of FIG. 2) trained based on training traffic sequence data (e.g., the training traffic sequence data of FIG. 4).

According to various embodiments, the trained first neural network (e.g., the autoencoder 210 of FIG. 2) may be an autoencoder including an encoder configured to receive traffic sequence data and output a traffic feature vector; and a decoder configured to restore traffic sequence data received by the encoder based on the traffic feature vector output by the encoder.

According to various embodiments, the second base station 1601 may obtain the prediction traffic data from the concatenation feature vector based on a second neural network (e.g., the prediction neural network 220 of FIG. 2) trained jointly with the first neural network 210 based on the training traffic sequence data.

According to various embodiments, the first network may be an NR network, and the second network may be an LTE network.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms, such as “first” or “second”, are simply used to distinguish a component from another component and do not limit the components in other aspects (e.g., importance or sequence). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. A machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a memory comprising instructions; and
a processor electrically connected to the memory and configured to execute the instructions,
wherein, when the instructions are executed by the processor, the processor is configured to:
obtain a first traffic feature vector and a second traffic feature vector based on traffic data generated in a wireless network device during a plurality of time intervals;
generate a concatenation feature vector by concatenating the first traffic feature vector and the second traffic feature vector; and
obtain prediction traffic data to be generated in the wireless network device based on the concatenation feature vector.

2. The electronic device of claim 1, wherein the processor is configured to:
generate first traffic sequence data and second traffic sequence data by aggregating traffic data generated in the wireless network device for each time interval during a first time interval and a second time interval; and
obtain each of the first traffic feature vector and the second traffic feature vector based on the first traffic sequence data and the second traffic sequence data.

3. The electronic device of claim 2, wherein
the second time interval has the same interval as the first time interval, and
a starting point of the second time interval is earlier than a starting point of the first time interval.

4. The electronic device of claim 3,
wherein the processor is configured to obtain each of the first traffic feature vector and the second traffic feature vector from the first traffic sequence data and the second traffic sequence data based on a first neural network trained based on training traffic sequence data.

5. The electronic device of claim 4, wherein the trained first neural network is an autoencoder comprising:
an encoder configured to receive traffic sequence data and output a traffic feature vector; and
a decoder configured to restore traffic sequence data received by the encoder based on the traffic feature vector output by the encoder.

6. The electronic device of claim 5, wherein the processor is configured to obtain the prediction traffic data from the concatenation feature vector based on a second neural network trained jointly with the first neural network based on the training traffic sequence data.

7. A base station comprising:
an antenna array comprising a plurality of antennas;
a communication module configured to exchange data with a plurality of user terminals performing communication with a first network or a second network via the antenna array; and
a processor operatively connected to the communication module,
wherein the processor is configured to:
for each of the plurality of user terminals, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector; and
perform dynamic spectrum sharing (DSS) of a heterogeneous network based on a plurality of prediction traffic data obtained for each of the plurality of user terminals.

8. The base station of claim 7, wherein the processor is configured to:
generate first traffic sequence data and second traffic sequence data by aggregating traffic data generated in the one user terminal for each time interval during a first time interval and a second time interval; and
obtain each of the first traffic feature vector and the second traffic feature vector based on the first traffic sequence data and the second traffic sequence data.

9. The base station of claim 8, wherein
the second time interval has the same interval as the first time interval, and
a starting point of the second time interval is earlier than a starting point of the first time interval.

10. The base station of claim 9, wherein the processor is configured to obtain each of the first traffic feature vector and the second traffic feature vector from the first traffic sequence data and the second traffic sequence data based on a first neural network trained based on training traffic sequence data.

11. The base station of claim 10, wherein the trained first neural network is an autoencoder comprising:
an encoder configured to receive traffic sequence data and output a traffic feature vector; and
a decoder configured to restore traffic sequence data received by the encoder based on the traffic feature vector output by the encoder.

12. The base station of claim 11, wherein the processor is configured to obtain the prediction traffic data from the concatenation feature vector based on a second neural network trained jointly with the first neural network based on the training traffic sequence data.

13. The base station of claim 7, wherein
the first network is any one of a long-term evolution (LTE) network or a new radio (NR) network, and
the second network is the remaining one of the LTE network or the NR network, that is different from the first network.

14. A communication system comprising:
a first base station configured to obtain a plurality of first network traffic data generated in each of a plurality of user terminals performing communication with a first network, and transmit the plurality of first network traffic data to a second base station; and
the second base station configured to obtain a plurality of second network traffic data generated in each of the plurality of user terminals performing communication with a second network, and perform dynamic spectrum sharing (DSS) of a heterogeneous network based on the plurality of first network traffic data and the plurality of second network traffic data,
wherein the second base station is configured to:
for each of the plurality of user terminals, obtain a first traffic feature vector and a second traffic feature vector based on traffic data generated in one user terminal during a plurality of time intervals, generate a concatenation feature vector by concatenating the first traffic feature vector and the second traffic feature vector, and obtain prediction traffic data to be generated in the one user terminal based on the concatenation feature vector; and
perform dynamic spectrum sharing (DSS) of a heterogeneous network based on a plurality of prediction traffic data obtained for each of the plurality of user terminals.

15. The communication system of claim 14, wherein the second base station is configured to:
generate first traffic sequence data and second traffic sequence data by aggregating traffic data generated in the one user terminal for each time interval during a first time interval and a second time interval; and
obtain each of the first traffic feature vector and the second traffic feature vector based on the first traffic sequence data and the second traffic sequence data.
